(19) United States
(12) Patent Application Publication
(10) Pub. No.: US 2008/0091895 A1
(43) Pub. Date: Apr. 17, 2008

(54) Cache data backup method and system for computer clustering systems

(75) Inventor: Chih-Wei Chen, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/546,871

(22) Filed: Oct. 11, 2006

(51) Int. Cl. G06F 12/16; G06F 12/00

(52) U.S. Cl. 711/162; 711/118

(57) ABSTRACT

A cache data method and system is proposed for use with a computer clustering system, such as an HA (High Availability) oriented server clustering system, for processing the cache data in each server unit of the server clustering system. The proposed cache data backup method and system is characterized by the use of a standby server unit to store a backup copy of the cache data in a main server unit, and where the standby server unit is capable of making update and permanent storage of the backup cache data promptly in synchronization with each update of the cache data in the main server unit. This feature allows the standby server unit to hold a complete backup copy of cache data in the event of a failure to the main server unit that causes a loss to all of the cache data.

### BACKGROUND OF THE INVENTION

1. Field of the Invention

This invention relates to information technology (IT), and more particularly, to a cache data processing method and system which is designed for use in conjunction with a computer clustering system, such as a High Availability (HA) oriented server clustering system, for providing each server unit of the server clustering system with a cache data backup capability.

2. Description of Related Art

High Availability (HA) is a key issue in the design and building of enterprise-class network server systems, which is intended for the purpose of allowing the network server systems to maintain a high level of availability at all times to the clients. With the HA feature, clients can always be able to link and gain access to network services without waiting or interruption.

To provide HA capability on enterprise-class network server systems, one solution is to utilize a clustering architecture which employs multiple server units to offer the same network service. By this clustering architecture, whenever one server unit fails, it can be immediately replaced by a standby server unit to offer the linked client with the same network service. This capability allows the server system to be able to provide network services to the clients uninterruptedly in the event of a failure to any server unit in the server system.

In practical applications, however, whenever a server unit fails, its cache memory may still contain some updated-but-not-yet-refreshed cache data. Consequently, although the failed server unit can pass its server function to a standby server unit, its cache data may be unrecoverable, thus causing loss of some important data.

Presently, there are many solutions to the backup of cache data in server systems, which allows the cache data on a host-side server unit to be backed up to a backup-side server unit. One drawback to these solutions, however, is that they don't have capability to back up the cache data in a synchronized real-time manner. For this sake, when the host-side server unit fails, some updated cache data may be still not yet backed up on the backup-side server unit and thus become unrecoverable.

### SUMMARY OF THE INVENTION

It is therefore an objective of this invention to provide a cache data processing method and system for use on a server clustering system to allow the cache data of a host-side server unit to be backed up to a backup-side server unit in a synchronized real-time manner, so as to ensure the cache data of the host-side server unit to be recoverable after a failure occurs to the host-side server unit.

The cache data processing method and system according to the invention is designed for use in conjunction with a computer clustering system, such as an HA (High Availability) oriented server clustering system, for providing each server unit of the server clustering system with a cache data processing capability in a synchronized real-time manner.

The cache data processing method according to the invention comprises: (S1) on the first computer platform, monitoring the cache status of the cache memory unit; and if any item of cache data is updated, issuing an update notification message; (S2) on the first computer platform, responding to the update notification message by performing an updated cache data handling procedure, whereby the dirty status of the updated cache data is set to true, and meanwhile a cache-data-update synchronization enable message is issued via the network link to the second computer platform; (S3) on the second computer platform, storing a backup copy of the updated cache data; (S4) on the second computer platform, responding to the cache-data-update synchronization enable message from the first computer platform by performing a synchronized updated cache data handling procedure, whereby the dirty status of each block of the backup cache data corresponding to the updated cache data is synchronously set to true; and (S5) on the second computer platform, responding to the cache-data-refreshing synchronization enable message from the first computer platform by performing a synchronized cache data refreshing procedure on the backup cache data whose dirty status is set to true, whereby each block of backup cache data corresponding to the updated cache data in the first computer platform is refreshed to a backup-side permanent data storage unit connected to the second computer platform.

In concrete architecture, the cache data backup system according to the invention is based on a distributed architecture which comprises: (A) a host-side unit for installation on the first computer platform; and (B) a backup-side unit for installation on the second computer platform; wherein the host-side unit includes: (A1) a host-side cache status monitoring module, which is capable of monitoring the cache status of the cache memory unit on the first computer platform; and if any item of cache data is updated, capable of responding by issuing an update notification message; (A2) a host-side cache update handling module, which is capable of responding to the update notification message from the host-side cache status monitoring module by performing an updated cache data handling procedure, whereby the dirty status of the updated cache data is set to true, and meanwhile a cache-data-update synchronization enable message is issued via the network link to the second computer platform; and (A3) a host-side cache data refreshing module, which is capable of performing a cache data refreshing procedure on the updated cache data in the cache memory unit, whereby the updated cache data is refreshed to a host-side permanent data storage unit connected to the first computer platform, and meanwhile a cache-data-refreshing synchronization enable message is issued via the network link to the second computer platform; and wherein the backup-side unit includes: (B1)a backup cache data storage module, which is used to store a backup copy of the cache data of the first computer platform; (B2) a backup-side cache update handling module, which is capable of responding to the cache-data-update synchronization enable message from the first computer platform by performing a synchronized updated cache data handling procedure, whereby the dirty status of each block of the backup cache data stored in the backup cache data storage module corresponding to the updated cache data is synchronously set to true; and (B3) a backup-side cache data refreshing module, which is capable of responding to the cache-data-refreshing synchronization enable message from the first computer platform by performing a synchronized cache data refreshing procedure on the backup cache data stored in the backup cache data storage module whose dirty status is set to true, whereby each block of backup cache data corresponding to the updated cache data in the first computer platform is refreshed to a backup-side permanent data storage unit connected to the second computer platform.

The cache data processing method and system according to the invention is characterized by the use of a standby server unit to store a backup copy of the cache data in a main server unit, and where the standby server unit is capable of making update and permanent storage of the backup cache data promptly in synchronization with each update of the cache data in the main server unit. This feature allows the standby server unit to hold a complete backup copy of cache data in the event of a failure to the main server unit that causes a loss to all of the cache data.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the application and distributed architecture of the cache data processing system according to the invention;

FIG. 2 is a schematic diagram showing an object-oriented component model of the cache data processing system of the invention; and

FIG. 3 is a schematic diagram showing an example of a set of cache status records utilized by the cache data processing system of the invention.

### DETAILED DESCRIPTION OF PREFERRED EMBODIMENTS

The cache data processing method and system according to the invention is disclosed in full details by way of preferred embodiments in the following with reference to the accompanying drawings.

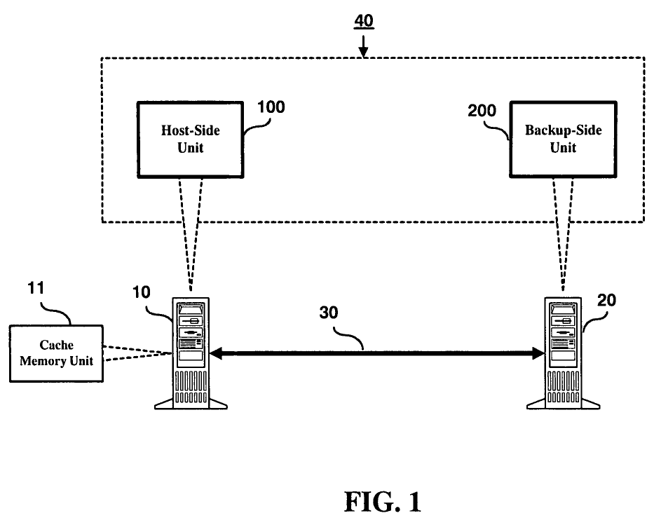

FIG. 1 is a schematic diagram showing the application and distributed architecture of the cache data processing system according to the invention (as the part enclosed in the dotted box indicated by the reference numeral 40). As shown, the cache data processing system of the invention 40 is based on a distributed architecture which is composed of a host-side unit 100 and a backup-side unit 200 for distributed integration to a first computer platform 10 and a second computer platform 20 in a computer clustering system. In the embodiment of FIG. 1, for example, the first computer platform 10 and the second computer platform 20 are two separate server units in an HA (High Availability) oriented server clustering system. In application, the first server unit 10 is typically equipped with a cache memory unit 11 for storing cache data.

In operation, the cache data processing system of the invention 40 is capable of providing the first server unit 10 with a cache data backup capability that allows the cache data stored in the cache memory unit 11 of the first server unit 10 to be continually backed up and refreshed to the second server unit 20 in a synchronized real-time manner, such that in the event of a failure to the first server unit 10, such as power failure or system crash, the second server unit 20 can hold a complete backup copy of the original cache data in the first server unit 10.

In the embodiment of FIG. 1, the cache data processing system of the invention 40 is used to back up the cache data in the first server unit 10 to the second server unit 20; however, it can also be used at the same time to back up the cache data in the second server unit 20 to the first server unit 10.

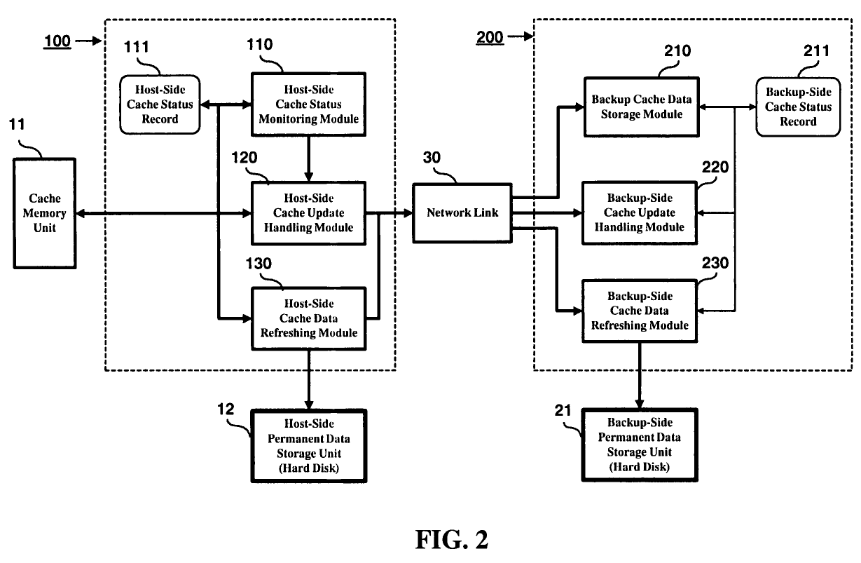

As shown in FIG. 2, the cache data processing system of the invention 40 is based on a distributed architecture comprising 2 separate units: (A) a host-side unit 100 for installation on the first server unit 10; and (B) a backup-side unit 200 for installation on the second server unit 20; and wherein as shown in FIG. 2, the host-side unit 100 includes: (A1) a host-side cache status monitoring module 110; (A2) a host-side cache update handling module 120; and (A3) a host-side cache data refreshing module 130; while the backup-side unit 200 includes: (B1) a backup cache data storage module 210; (B2) a backup-side cache update handling module 220; and (B3) a backup-side cache data refreshing module 230. Firstly, the respective attributes and behaviors of these constituent components are described in details in the following

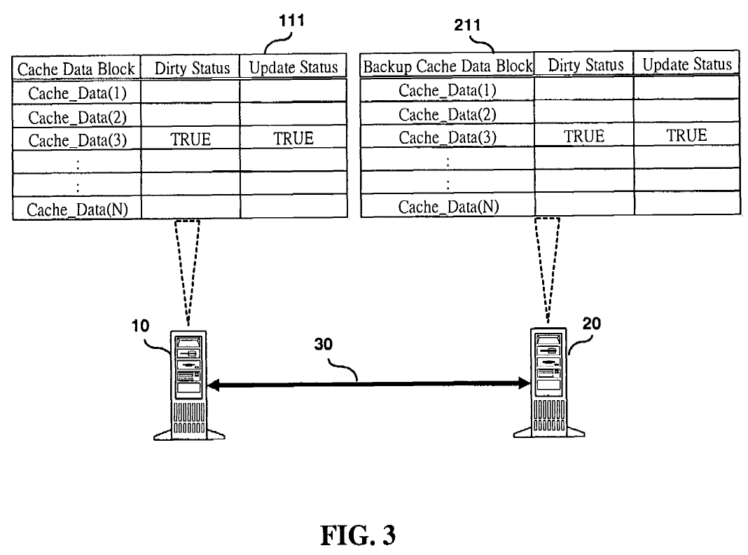

The host-side cache status monitoring module 110 is equipped with a host-side cache status record 111 as shown in FIG. 3, which is used to record the status of each block of cache data currently stored in the cache memory unit 11. In practical implementation, for example, this host-side cache status record 111 can be realized by using an LRU (Least Recently Used) list (which is a commonly used cache data handling method), which records a set of status data, including, for example, dirty status and update status. If the dirty status is “TRUE”, it represents that the associated block of cache data has been updated but not yet refreshed to the host-side permanent data storage unit 12 (which can be either a hard disk module or a flash memory module) on the first server unit 10; while if the update status is “TRUE”, it represents that the associated block of cache data has been refreshed to the host-side permanent data storage unit 12. It is to be noted that the host-side cache status record 111 shown in FIG. 3 only lists those pieces of data that are related to the invention; in practice, it may contain various other pieces of status data, such as the memory address of each piece of cache data, number of accesses, to name just a few. During actual operation, the host-side cache status monitoring module 110 is capable of continually monitoring the cache status of the cache memory unit 11 on the first computer platform; and if any block of cache data is updated, capable of responding by issuing an update notification message to the host-side cache update handling module 120. In the embodiment of FIG. 3, for example, it is assumed that the third block of cache data CACHE_DATA(3) is updated, then the host-side cache status monitoring module 110 will respond promptly by issuing an update notification message to the host-side cache update handling module 120.

The host-side cache update handling module 120 is capable of responding to the update notification message from the host-side cache status monitoring module 110 by performing an updated cache data handling procedure, whereby the dirty status of the updated cache data is set to “TRUE” (which indicates that this block of cache data is updated but not yet refreshed), and meanwhile a cache-data-update synchronization enable message is issued via the network link 30 to the second server unit 20. In the example of FIG. 3 where the third block of cache data CACHE_DATA(3) is updated, the host-side cache update handling module 120 will set the dirty status of CACHE_DATA(3) to “TRUE”.

The host-side cache data refreshing module 130 is capable of performing a cache data refreshing procedure on each block of cache data in the cache memory unit 11 whose dirty status is set to “TRUE”, whereby each block of updated cache data is refreshed for permanent storage on a host-side permanent data storage unit 12 (such as a hard disk module) connected to the first server unit 10, and meanwhile a cache-data-refreshing synchronization enable message is issued via the network link 30 to the second computer platform. In the example of FIG. 3 where the third block of cache data CACHE_DATA(3) is updated, the host-side cache data refreshing module 130 will refresh the updated contents of CACHE_DATA(3) to the hard disk module 12, and after the refreshing is completed, set the update status of CACHE_DATA(3) to “TRUE”.

The backup cache data storage module 210 is for example a flash memory module installed on the second server unit 20 for storing a backup copy of all the cache data currently stored in the cache memory unit 11 of the first server unit 10. This backup cache data storage module 210 is equipped with a backup-side cache status record 211 as shown in FIG. 3, which is used to record the status of each block of backup cache data currently stored in the backup cache data storage module 210. In practical implementation, for example, this backup-side cache status record 211 can be also realized by using an LRU list, which records a set of status data, including, for example, dirty status and update status. If the dirty status is “TRUE”, it represents that the associated block of backup cache data has been updated but not yet refreshed to the backup-side permanent data storage unit 22 (which can be either a hard disk module or a flash memory module) on the second server unit 20; while if the update status is “TRUE”, it represents that the associated block of backup cache data has been refreshed to the backup-side permanent data storage unit 22.

The backup-side cache update handling module 220 is capable of responding to the cache-data-update synchronization enable message (which is issued by the host-side cache update handling module 120 in the host-side unit 100 installed on the first server unit 10) by performing a synchronized updated cache data handling procedure on the backup cache data stored in the backup cache data storage module 210, whereby the dirty status of each block of the backup cache data stored in the backup cache data storage module 210 corresponding to the updated cache data stored in the cache memory unit 11 of the first server unit 10 is synchronously set to “TRUE”. In practical implementation, for example, this synchronized updated cache data handling procedure can be realized by the following steps:

(S1) searching through the backup-side cache status record 211 to check if the backup-side cache status record 211 contains a block of backup cache data corresponding to the updated cache data in the first server unit 10 that has been stored in the backup cache data storage module 210; if YES, jumping to Step (S2); otherwise, jumping to Step (S3);

(S2) updating the corresponding block of backup cache data; and

(S3) adding a new record of backup cache data to the backup-side cache status record 211, and then assigning a storage area in the backup cache data storage module 210 for storing a backup copy of the updated cache data.

In the example of FIG. 3 where the third block of cache data CACHE_DATA(3) is updated, if CACHE_DATA(3) is a newly added block of cache data, then the backup-side cache update handling module 220 will first add a new record of backup cache data to the backup-side cache status record 211, and then assign a storage area in the backup cache data storage module 210 for storing a backup copy of CACHE_DATA(3); otherwise, if CACHE_DATA(3) is an existing block of cache data that has been modified, the backup-side cache update handling module 220 will simply set the dirty status of the backup copy of CACHE_DATA(3) to “TRUE”.

The backup-side cache data refreshing module 230 is capable of responding to the cache-data-refreshing synchronization enable message (which is issued by the host-side cache data refreshing module 130 in the host-side unit 100 installed on the first server unit 10) by performing a synchronized cache data refreshing procedure on the backup cache data stored in the backup cache data storage module 210 whose dirty status is set to “TRUE”, whereby each block of backup cache data corresponding to the updated cache data in the first server unit 10 is refreshed for permanent storage on a backup-side permanent data storage unit 22 on the second server unit 20. In the example of FIG. 3 where the third block of cache data CACHE_DATA(3) is updated, the backup-side cache data refreshing module 230 will refresh the updated contents of CACHE_DATA(3) to the hard disk module 22 on the second server unit 20, and after the refreshing is completed, set the update status of CACHE_DATA(3) to “TRUE”.

The following is a detailed description of a practical application example of the host-side unit 100 during actual operation. In this application example, it is assumed that the cache memory unit 11 of the first server unit 10 currently stores N blocks of cache data CACHE_DATA(1), CACHE_DATA (2), CACHE_DATA(3) . . . , CACHE_DATA(N), where the contents of CACHE_DATA(3) is updated.

In the event of CACHE_DATA(3) being updated, the host-side cache status monitoring module 110 responds promptly by issuing an update notification message to the host-side cache update handling module 120. In response, the host-side cache update handling module 120 sets the dirty status of CACHE_DATA(3) to “TRUE”, and meanwhile issues a cache-data-update synchronization enable message via the network link 30 to the second server unit 20. However, if CACHE_DATA(3) is a newly added block of cache data, the backup-side cache update handling module 220 will first add a new record of backup cache data to the backup-side cache status record 211, and then assign a storage area in the backup cache data storage module 210 for storing a backup copy of CACHE_DATA(3).

Subsequently, the host-side cache data refreshing module 130 is activated to refresh the updated contents of CACHE_DATA(3) to the hard disk module 12 on the first server unit 10; and then after the refreshing is completed, the host-side cache data refreshing module 130 sets the update status of CACHE_DATA(3) to “TRUE”, and meanwhile issues a cache-data-refreshing synchronization enable message via the network link 30 to the second server unit 20. In response, the backup-side cache data refreshing module 230 in the backup-side unit 200 installed on the second server unit 20 is activated to refresh the updated contents of CACHE_DATA(3) to the hard disk module 22 on the second server unit 20, and then after the refreshing is completed, set the update status of CACHE_DATA(3) to “TRUE”.

In the event of a failure to the first server unit 10 that causes a loss to all the cache data in the cache memory unit 11, since all the cache data has been backed up to the backup cache data storage module 210 in the backup-side unit 200 installed on the second server unit 20, it allows the first server unit 10 to recovery all the cache data from the second server unit 20 after resuming to normal operation.

In conclusion, the invention provides a cache data backup method and system which is designed for use in conjunction with an HA-oriented server clustering system for providing each server unit of the server clustering system with a cache data backup capability, and which is characterized by the use of a standby server unit to store a backup copy of the cache data in a main server unit, and where the standby server unit is capable of making update and permanent storage of the backup cache data promptly in synchronization with each update of the cache data in the main server unit. This feature allows the standby server unit to hold a complete backup copy of cache data in the event of a failure to the main server unit that causes a loss to all of the cache data.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A cache data processing method for use on a computer clustering system having a first computer platform and a second computer platform, where the first computer platform and the second computer platform are interconnected via a network link, and where the first computer platform is equipped with a cache memory unit for storing cache data;
the cache data processing method comprising:
on the first computer platform, monitoring a cache status of the cache memory unit; and if any item of cache data stored in the memory unit is updated, issuing an update notification message;
on the first computer platform, responding to the update notification message by performing an updated cache data handling procedure on the cache data to create updated cache data, whereby an update statue of the updated cache data is set to true, and meanwhile a cache-data-update synchronization enable message is issued via the network link to the second computer platform;
on the first computer platform, storing the cache data having the update status set to be true on the first computer platform as a backup cache data; and
on the second computer platform, responding to the cache-data-update synchronization enable message and performing a cache altering processing process on the backup cache data synchronously to mark corresponding backup cache data as backup cache data having the update status set to be true.

2. The cache data processing method of claim 1 further comprising:
on the first platform, performing a cache data refreshing procedure on the updated cache data in the cache memory unit, whereby the backup cache data having the update status set to be true is refreshed to a host-side permanent data storage unit connected to the first computer platform, and meanwhile a cache-data-refreshing synchronization enable message is issued via the network link to the second computer platform; and
on the second computer platform, responding to the cache-data-refreshing synchronization enable message from the first computer platform by performing a synchronized cache data refreshing procedure on the backup cache data having the update status set to be true, whereby each block of backup cache data corresponding to the updated cache data in the first computer platform is refreshed to a backup-side permanent data storage unit connected to the second computer platform.

3. A cache data processing method for use on a computer clustering system having a first computer platform and a second computer platform, where the first computer platform and the second computer platform are interconnected via a network link, and where the first computer platform is equipped with a cache memory unit, for providing the cache memory unit of the first computer platform with a cache data processing capability;
the cache data processing method comprising:
on the first computer platform, monitoring a cache status of the cache memory unit; and if any item of cache data stored in the memory unit is updated, issuing an update notification message;
on the first computer platform, responding to the update notification message by performing an updated cache data handling procedure on the cache data to create updated cache data, whereby a dirty statue of the updated cache data is set to true, and meanwhile a cache-data-update synchronization enable message is issued via the network link to the second computer platform;
on the first computer platform, performing a cache data refreshing procedure on the updated cache data in the cache memory unit, whereby the updated cache data is refreshed to a host-side permanent data storage unit connected to the first computer platform, and meanwhile a cache-data-refreshing synchronization enable message is issued via the network link to the second computer platform;
on the second computer platform, storing a backup copy of the updated cache data as backup cache data;
on the second computer platform, responding to the cache-data-update synchronization enable message from the first computer platform by performing a synchronized updated cache data handling procedure, whereby the dirty status of each block of the backup cache data corresponding to the updated cache data is synchronously set to true; and
on the second computer platform, responding to the cache-data-refreshing synchronization enable message from the first computer platform by performing a synchronized cache data refreshing procedure on the backup cache data whose dirty status is set to true, whereby each block of backup cache data corresponding to the updated cache data in the first computer platform is refreshed to a backup-side permanent data storage unit connected to the second computer platform.

4. The cache data processing method of claim 3, wherein the first computer platform and the second computer platform are each a network server.

5. The cache data processing method of claim 3, wherein the host-side permanent data storage unit on the first computer platform is a hard disk module.

6. The cache data processing method of claim 3, wherein the backup-side permanent data storage unit on the second computer platform is a hard disk module

7. The cache data processing method of claim 3, wherein the host-side permanent data storage unit on the first computer platform is a flash memory module.

8. The cache data processing method of claim 3, wherein the backup-side permanent data storage unit on the second computer platform is a flash memory module.

9. A cache data processing system for use with a computer clustering system having a first computer platform and a second computer platform, where the first computer platform and the second computer platform are interconnected via a network link, and where the first computer platform is equipped with a cache memory unit, for providing the cache memory unit of the first computer platform with a cache data processing capability;
the cache data processing system comprising a host-side unit and a backup-side unit;
wherein
the host-side unit is installed on the first computer platform, and which includes:
a host-side cache status monitoring module, which is capable of monitoring a cache status of the cache memory unit on the first computer platform; and if any item of cache data stored in the cache memory unit is updated, capable of responding by issuing an update notification message;
a host-side cache update handling module, which is capable of responding to the update notification message from the host-side cache status monitoring module by performing an updated cache data handling procedure on the cache data stored in the cache memory unit to create updated cache data, whereby a dirty status of the updated cache data is set to true, and meanwhile a cache-data-update synchronization enable message is issued via the network link to the second computer platform; and
a host-side cache data refreshing module, which is capable of performing a cache data refreshing procedure on the updated cache data in the cache memory unit, whereby the updated cache data is refreshed to a host-side permanent data storage unit connected to the first computer platform, and meanwhile a cache-data-refreshing synchronization enable message is issued via the network link to the second computer platform; and
wherein
the backup-side unit is installed on the second computer platform, and which includes:
a backup cache data storage module, which is used to store a backup copy of the cache data of the first computer platform as backup cache data;
a backup-side cache update handling module, which is capable of responding to the cache-data-update synchronization enable message from the first computer platform by performing a synchronized updated cache data handling procedure, whereby the dirty status of each block of the backup cache data stored in the backup cache data storage module corresponding to the updated cache data is synchronously set to true; and
a backup-side cache data refreshing module, which is capable of responding to the cache-data-refreshing synchronization enable message from the first computer platform by performing a synchronized cache data refreshing procedure on the backup cache data stored in the backup cache data storage module whose dirty status is set to true, whereby each block of backup cache data corresponding to the updated cache data in the first computer platform is refreshed to a backup-side permanent data storage unit connected to the second computer platform.

10. The cache data processing system of claim 9, wherein the first computer platform and the second computer platform are each a network server.

11. The cache data processing system of claim 9, wherein the host-side permanent data storage unit on the first computer platform is a hard disk module.

12. The cache data processing system of claim 9, wherein the backup-side permanent data storage unit on the second computer platform is a hard disk module

12. The cache data processing system of claim 9, wherein the host-side permanent data storage unit on the first computer platform is a flash memory module.

14. The cache data processing system of claim 9, wherein the backup-side permanent data storage unit on the second computer platform is a flash memory module.
